(19) United States
(12) Patent Application Publication
(10) Pub. No.: US 2001/0006614 A1
(43) Pub. Date: Jul. 5, 2001

(54) Process for recovery and recycle of ammonia from an acrylonitrile reactor effluent stream using an ammonium phosphate quench system

(76) Inventors: Linda L. Nero, Columbia Station, OH (US); Loring A. Weisenberger, Willowick, OH (US)

Correspondence Address: BP Amoco Corporation, Docket Clerk, Law Department, M.C. 2007A, 200 East Randolph Drive, Chicago, IL, 60601-7125, US

(21) Appl. No.: 09/740,077

(22) Filed: Dec. 18, 2000

Related U.S. Application Data
(63) Continuation of application No. 09/219,587, filed on Dec. 23, 1998, now abandoned.

(51) Int. Cl. B01D 53/14

(52) U.S. Cl. 423/238; 95/178; 95/251

(57) ABSTRACT

The present invention provides a process for the recovery of unreacted ammonia from the effluent obtained from a reaction zone wherein oxygen, ammonia and a hydrocarbon are reacted at an elevated temperature in the presence of an ammoxidation catalyst to produce an unsaturated nitrile is provided, including the steps of:

quenching the effluent containing the nitrile and unreacted ammonia with an aqueous ammonium phosphate solution having an initial ratio R of ammonium ions to phosphate ions to absorb substantially all of the unreacted ammonia present in the reactor effluent to form an ammonium phosphate solution having an increased ratio R of ammonium ions to phosphate ions;

heating the solution to an elevated temperature sufficient to reduce the ratio R of ammonium ions to phosphate ions and to generate a vaporous stream containing ammonia;

passing the heated solution through a ³¹P nuclear magnetic resonance detector to detect a chemical shift of a ³¹P nuclear magnetic resonance peak;

determining the ratio R of ammonium ions to phosphate ions in the solution based on the chemical shift; and

controlling the heating step to maintain the initial ratio within a desired range.

### TECHNICAL FIELD

The present invention relates to a process for the recovery and regeneration of ammonia contained in the effluent obtained from a reaction zone where ammonia and oxygen are reacted with a hydrocarbon to produce the corresponding unsaturated nitrile. In particular, the present invention relates to controlling a process for the recovery and regeneration of unreacted ammonia contained in the effluent passing from a reaction zone wherein ammonia and oxygen are reacted with a hydrocarbon to produce the corresponding nitrile, such as propane to produce acrylonitrile or isobutane to produce methacrylonitrile, by determining the ratio R of ammonium ions to phosphate ions in an ammonium phosphate solution in a quench bottom stream by means of ³¹P nuclear magnetic resonance (³¹P NMR). While these two hydrocarbons are preferred and are used for illustrative purposes, the process of the present invention relates to any process in which ammonia is contained in and is desired to be removed from an effluent from an ammoxidation-type reaction.

### BACKGROUND OF THE INVENTION

U.S. Pat. Nos. 3,936,360 and 3,649,179 are each directed to a process for the manufacture of acrylonitrile utilizing propylene, oxygen and ammonia as the reactants. These gases are passed over a catalyst in a fluid bed reactor to produce acrylonitrile which passes from the reactor to a recovery and purification section. This reactor effluent includes some unreacted ammonia which is typically removed from the process by treatment in the quench tower with an acid. The '179 patent discloses that the quench acid may be either sulfuric, hydrochloric, phosphoric or nitric acid. The '360 patent teaches the use of sulfuric acid in the quench to remove the unreacted ammonia. In the manufacture of acrylonitrile using propylene as the hydrocarbon source, the preferred embodiments utilize sulfuric acid resulting in the formation of ammonium sulfate. Typically, the ammonium sulfate is either recovered and sold as a co-product (fertilizer) or may be combined with other heavy organics produced in the process and deep-welled for safe disposal.

Great Britain Patent 222,587 is directed to ammonium recovery from an ammonia-containing gas mixture utilizing an aqueous phosphoric acid solution, an aqueous solution of ammonium hydrogen phosphate ((NH₄)H₂PO₄), or mixtures thereof. The ammonia is recovered by heat decomposition and dissolving the resulting residue in water to regenerate the ammonium recovery phosphate solution. This ammonia recovery process is directed to the recovery of ammonia from coal gas or coke ovens at temperatures of 50° C. to 70° C.

U.S. Pat. Nos. 2,797,148 and 3,718,731 are directed to the recovery of ammonia from a process stream used in the production of HCN. The process of recovery uses an ammonium phosphate solution to capture the ammonia and then uses steam stripping to regenerate the ammonia from the ammonium phosphate solution. Typically, the process is operated by contacting the ammonia-containing gas with a 25% to 35% by weight ammonium phosphate solution having a pH of about 6 at a temperature of between 55° C. to 90° C. Ammonia regeneration is affected by contacting the resulting ammonium phosphate solution with steam. The processes in each of these patents disclose that the ammonium ion/phosphate ion ratio R is at least 1.2 or greater.

The problem of excess ammonia in ammoxidation processes has been dealt with in other ways as well. For example, in an effort to avoid formation of ammonium sulfate which must be disposed, e.g., in injection wells, U.S. Pat. No. 5,288,473 discloses injecting an organic compound, such as methanol, into the ammoxidation reactor for reaction with, and thus destruction of, the excess ammonia. Such processes, while avoiding the undesirable production of ammonium sulfate, generate other materials which must be disposed. Such processes result in quench bottoms having a high level of total organic carbon (TOC), which requires additional processing to be rendered environmentally acceptable, although not totally harmless (e.g., CO₂).

Therefore, a need remains for a process in which the excess ammonia from an ammoxidation reaction may be recovered and recycled. Such a process should preferably be as efficient as possible and should not generate additional by-products which must be disposed.

### SUMMARY OF THE INVENTION

The present invention provides a process for the recovery of unreacted ammonia from the effluent obtained from a reaction zone wherein oxygen, ammonia and a hydrocarbon are reacted at an elevated temperature in the presence of an ammoxidation catalyst to produce an unsaturated nitrile is provided, including the steps of:

quenching the effluent containing the nitrile and unreacted ammonia with an aqueous ammonium phosphate solution having an initial ratio R of ammonium ions to phosphate ions to absorb substantially all of the unreacted ammonia present in the reactor effluent to form an ammonium phosphate solution having an increased ratio R of ammonium ions to phosphate ions;

heating the solution to an elevated temperature sufficient to reduce the ratio R of ammonium ions to phosphate ions and to generate a vaporous stream containing ammonia;

passing the heated solution through a ³¹P nuclear magnetic resonance detector to detect a chemical shift of a ³¹P nuclear magnetic resonance peak;

determining the ratio R of ammonium ions to phosphate ions in the solution based on the chemical shift; and

controlling the heating step to maintain the initial ratio within a desired range.

In one embodiment, the process of the present invention includes the step of continuously recycling the ammonium phosphate solution from the heating step for use in the quenching step.

In one embodiment, the process includes the steps of passing the ammonium phosphate solution through a second ³¹P nuclear magnetic resonance detector prior to the heating step to determine the ratio R of ammonium ions to phosphate ions based on the chemical shift, and controlling the process to maintain both the initial and increased ratios of ammonium ion to phosphate ions within desired ranges.

In one embodiment, the process includes the step of continuously recycling the vaporous stream containing ammonia to the ammoxidation reaction zone.

In one embodiment, the process includes treating the aqueous ammonium phosphate solution with a stripping gas to remove substantially all of the acrylonitrile and other useful co-products from the second solution, prior to heating the solution to decrease the ammonium ion content.

In one embodiment, the stripping gas containing acrylonitrile is recycled for recovery and purification of the acrylonitrile.

In one embodiment the ammonium phosphate solution after stripping and ammonia removal is transferred to a wet oxidation reactor whereby the solution is subjected to wet oxidation at an elevated temperature and pressure to remove any heavy organics contained in the quench solution.

In one embodiment, the second solution after ammonia removal is transferred to an evaporator to remove excess water from the ammonium phosphate solution to provide a more concentrated phosphate solution, which is recycled for use in the quenching step.

In one embodiment, the present invention provides a process for the recovery of unreacted ammonia from the effluent obtained from a reaction zone wherein oxygen, ammonia and a hydrocarbon are reacted at an elevated temperature in the presence of an ammoxidation catalyst to produce an unsaturated nitrile, including the steps of:

quenching the effluent containing the nitrile and unreacted ammonia with an ammonium phosphate solution having an initial ratio R of ammonium ions to phosphate ions to absorb substantially all of the unreacted ammonia present in the reactor effluent whereby the ammonium phosphate solution has an increased ratio R of ammonium ions to phosphate ions;

heating the solution to an elevated temperature sufficient to reduce the ratio R and to generate a vaporous stream containing ammonia for recycling to the reaction zone;

passing the solution through a ³¹P nuclear magnetic resonance detector to detect a chemical shift of a ³¹P nuclear magnetic resonance peak;

determining the ratio of ammonium ions to phosphate ions in the solution based on the chemical shift; and

controlling the heating step to maintain the first ratio within a desired range.

In one embodiment, the present invention provides a process for the recovery of unreacted ammonia from the effluent obtained from a reaction zone wherein oxygen, ammonia and a hydrocarbon selected from propane and isobutane are reacted at an elevated temperature in the presence of an ammoxidation catalyst to produce a corresponding unsaturated nitrile, comprising the steps of:

quenching the effluent containing the corresponding nitrile and unreacted ammonia with an ammonium phosphate solution wherein the ratio R of ammonium ions to phosphate ions is between about 0.7 to about 1.3 to absorb substantially all of the unreacted ammonia present in the reactor effluent to form an ammonium phosphate solution having an increased ratio R ammonium ions to phosphate ions;

heating the solution to an elevated temperature sufficient to reduce the amount of ammonium ions in the solution to substantially the initial ratio R present in the solution and to generate a vaporous stream containing ammonia for recycling to the fluid bed reactor;

passing the ammonium phosphate solution through a ³¹P nuclear magnetic resonance detector to detect a chemical shift of a ³¹P nuclear magnetic resonance peak;

determining the ratio of ammonium ions to phosphate ions in the solution based on the chemical shift; and

controlling the heating step to maintain the ratio R within a desired range.

The present invention provides an advantage in that the ammonia recovery process may be optimally controlled by use of ³¹P NMR to determine and control a ratio R of ammonium ions to phosphate ions in the ammonium phosphate quench solution. For a solution containing all monoammonium phosphate, (NH₄)H₂PO₄ (“MAP”), the ratio R=1.0. For a solution containing all diammonium phosphate, (NH₄)₂HPO₄ (“DAP”), the ratio R=2.0. For solutions containing mixtures of these two phosphate salts, the ratio R is intermediate between R=1 and R=2. In the process, the value of the ratio R may be adjusted and controlled by adjusting the conditions of the quenching and ammonia recovery (heating) steps of the process so as to optimize recovery of ammonia while operating the recovery process at maximum efficiency.

An advantage of the present invention is its provision of a process for the recovery and/or regeneration of ammonia contained in the effluent from a reactor zone where ammonia, oxygen and a hydrocarbon such as propane or isobutane are reacted in an ammoxidation reaction to produce an unsaturated nitrile such as, respectively, acrylonitrile or methacrylonitrile, which may be optimized by determining the amount of ammonia in an ammonium phosphate quench stream by use of ³¹P nuclear magnetic resonance spectroscopy and controlling the amount of ammonia in the quench stream by adjusting the operating conditions of the recycling process. The amount of ammonia may be determined from the ratio of ammonium ions to phosphate ions in the solution, based on the chemical shift of the ³¹P NMR peak.

It is another advantage of the present invention that the necessity for disposing of excess ammonia which remains in the reaction mixture from the ammoxidation of propane to acrylonitrile may be avoided.

It is another advantage of the present invention that formation and disposal of additional chemical compounds resulting from removal of ammonia by an irreversible or inefficiently reversible chemical reaction with an agent such as methanol or sulfuric acid may be avoided.

It is still another advantage of the present invention to efficiently recover and recycle ammonia from a propane ammoxidation reaction without any significant loss of the ammonia.

Other advantages as well as other aspects and features and advantages of the present invention will become apparent for those of skill in the art from consideration of the specification including the drawings and the claims.

The quench system of the present invention results in additional advantages in propane ammoxidation compared to propylene ammoxidation in the production of acrylonitrile. Among these advantages are: (1) complete capture of by-product acrolein, thus enhancing product recovery efficiency by minimizing loss of product through, for example, reaction of acrolein with HCN in the product separation and recovery train of the process, (2) lower TOC in the quench bottoms, (3) higher percentage of organics present in the quench bottoms are present as strippable/recoverable monomers instead of unrecoverable waste polymers and (4) the ability to use a lower severity waste organic treatment (e.g., wet oxidation) because of the presence of lower TOC and polymers in the quench bottoms solution. A further advantage feature of the process of the present invention is that all the waste water streams may be readily handled by conventional biotreatment processes unlike the waste streams associated with propylene ammoxidation to manufacture acrylonitrile.

The process of the present invention has several advantages over the prior art practice used in propylene ammoxidation because it efficiently removes unreacted ammonia from the ammoxidation process, recovers the ammonia for recycling, and avoids the formation of an ammonium salt-containing waste stream that must either be (1) treated to recover the ammonium salt or (2) disposed of in an environmentally safe manner.

### BRIEF DESCRIPTION OF THE DRAWINGS

FIG. 1 is a superimposition of the ³¹P NMR absorption peaks of four ³¹ P NMR spectra, each peak representing one ratio R of ammonium ions to phosphate ions in an ammonium phosphate solution in accordance with the present invention.

FIG. 2 is a flow diagram of one embodiment of the present invention.

FIG. 3 is a flow diagram of a second embodiment of the present invention.

### DETAILED DESCRIPTION OF THE INVENTION

The present invention relates to controlling a process for the recovery and regeneration of unreacted ammonia contained in the effluent passing from a reaction zone wherein ammonia and oxygen are reacted with a hydrocarbon to form the corresponding unsaturated nitrile, by determining the ratio R of ammonium ions to phosphate ions in an ammonium phosphate solution in a quench stream by means of ³¹P nuclear magnetic resonance (³¹P NMR). In one embodiment, the reaction takes place in a fluid bed reactor, although other types of reactors such as transport line reactors are envisioned as suitable in the practice of the invention. In one embodiment, the hydrocarbon is propane and the ammoxidation reaction produces acrylonitrile. In one embodiment, the hydrocarbon is isobutane and the ammoxidation reaction produces methacrylonitrile. Other hydrocarbons may be used in the ammoxidation to produce corresponding unsaturated nitriles. Fluid bed propane ammoxidation reaction conditions and fluid bed catalysts useful in propane ammoxidation are known in the art as evidenced by, e.g., U.S. Pat. No. 4,746,641 assigned to the assignee of the present application and herein incorporated by reference. The novel process of the present invention comprises the steps of (1) quenching the reactor effluent obtained from the reaction of ammonia, oxygen and a hydrocarbon in a reaction zone (e.g., a fluidized bed reactor) to produce an unsaturated nitrile with an aqueous ammonium phosphate solution having an initial ratio R of ammonium ions to phosphate ions, thereby absorbing ammonia to increase the ratio R of ammonium ions to phosphate ions in the ammonium phosphate solution, (2) heating the solution to an elevated temperature to reduce the ammonium ion to phosphate ion ratio R in the solution and to generate a vaporous stream containing ammonia and water, (3) passing the heated solution through a ³¹P nuclear magnetic resonance detector to detect the chemical shift of the ³¹P nuclear magnetic resonance peak, (4) determining the ratio R, of ammonium ions to phosphate ions based on the chemical shift, and (5) controlling the heating step to maintain the initial ratio R of ammonium ions to phosphate ions within a desired range.

In one embodiment, the process includes the steps of passing the ammonium phosphate solution through a second ³¹P nuclear magnetic resonance detector prior to the heating step to determine the ratio R of ammonium ions to phosphate ions based on the chemical shift, and controlling the process to maintain both the initial and increased ratios of ammonium ion to phosphate ions within desired ranges.

In one embodiment, the process includes the step of recycling the vaporous stream containing ammonia to the ammoxidation reaction zone. The recovered ammonia may be subjected to further purification and/or concentration prior to its recycle into the ammoxidation reactor. The steps by which the recovered ammonia may be purified and/or concentrated are known to those of skill in the art. Recycling the ammonia is one of the major benefits of the present process, the efficiency of which is enhanced by the present invention.

In one embodiment, the process includes a stripping step of treating the ammonium phosphate quench solution with a stripping gas to remove substantially all of the acrylonitrile and other useful co-products from the second solution prior to the heating step. In this stripping step, a gas such as propane, nitrogen, carbon dioxide or carbon monoxide, for example, is passed through the quench solution, in order to flush or wash out acrylonitrile and other useful co-products or by-products of the ammoxidation reaction. The stripping gas exiting the stripping step may be passed into the quenching tower or separately treated to recover the acrylonitrile and other useful co-products or by-products of the ammoxidation reaction The stripping step results in significant reduction of organics in the ammonium phosphate solution and improved yields, leading to a more efficient ammoxidation process.

In one embodiment, the temperature of the ammonium phosphate solution when used in the quenching step is in the range from about 40° C. to about 80° C. In one embodiment, the temperature is in the range from about 50° C. to about 70° C. In one embodiment, the temperature is in the range from about 55°C. to about 65° C. In one embodiment, the temperature is about 50° C. In one embodiment, the temperature is about 60° C.

Typically, the quench solution fed into the quenching step has an initial ratio R of ammonium ions to phosphate ions in the range from about 0.7 to about 1.3. In one embodiment, the initial ratio R is in the range from about 0.9 to about 1.2. In one embodiment, the initial ratio R is in the range from about 1.0 to about 1.2. In one embodiment, the initial ratio R is about 1.0, i.e., the solution contains substantially only MAP.

The resulting pH of the quench solution is in the range from about 2 to about 6 prior to the quenching step. In one embodiment, the pH of the quench solution is in the range from about 3 to 5 prior to the quenching step. In one embodiment, the pH of the quench solution is about 3 prior to the quenching step. In one embodiment, the pH of the quench solution is in the range from about 2.5 to about 5.0 prior to the quenching step. In one embodiment, the pH of the quench solution is in the range from about 2.8 to about 6.0 prior to the quenching step.

The phosphate ion concentration in the quench solution may be in the range from about 5% by weight to about 50% by weight. In one embodiment, the phosphate ion concentration in the quench solution is about 40% by weight. In one embodiment, the phosphate ion concentration in the quench solution is about 35% by weight. In one embodiment, the phosphate ion concentration in the quench solution is in the range from about 30% by weight to about 45% by weight.

In the quenching step of the process, the effluent from the fluid bed reactor passes into a quench tower, and the effluent is contacted with an ammonium phosphate quench solution. When the ammonium phosphate quench solution enters the quench tower, it has an initial ratio R of ammonium ions to phosphate ions. In the quenching step, the ammonium phosphate solution reacts with free ammonia (or ammonium ions in solution) to form an ammonium phosphate solution having an increased ratio R of ammonium ions to phosphate ions. Thus, for example, some of the monoammonium phosphate, ((NH₄)H₂PO₄, MAP) in the solution reacts with ammonia to form diammonium phosphate ((NH₄)₂HPO₄, DAP), in the following general reaction:

(NH₄)H₂PO₄+NH₃→(NH₄)₂HPO₄ I

The foregoing reaction (I) may be expressed as follows, if the ammonia is considered to be present in the form of ammonium ions in an acidic solution:

(NH₄)H₂PO₄+NH₄⁺→(NH₄)₂HPO₄+H⁺ II

Of course, in the actual solution an appropriate anionic counterion to balance the ammonium ion is present.

In one embodiment, the original quench solution comprises a mixture of a monoammonium phosphate/phosphoric acid aqueous solution (90% monoammonium phosphate 10% H₃PO₄). In one embodiment, a lean aqueous monoammonium phosphate solution containing no added phosphoric acid is used. When the aqueous monoammonium phosphate solution is used in the process, the unreacted ammonium present in the reactor effluent is absorbed to convert some of the monoammonium phosphate in solution to diammonium phosphate.

Following the quenching step, the ammonium phosphate solution has an increased ratio R of ammonium ions to phosphate ions. In one embodiment, the quench solution has an increased ratio R of ammonium ions to phosphate ions in the range from about 1.1 to about 1.7. In one embodiment, the increased ratio R is in the range from about 1.3 to about 1.5. In one embodiment, the increased ratio R is in the range from about 1.35 to about 1.45. In one embodiment, the increased ratio R is about 1.4. In one embodiment, the increased ratio R is in the range from about 1.2 to about 2.0.

During the quenching step, the products (acrylonitrile, acetonitrile and HCN) are removed as overheads and are substantially free of ammonia. The quench solution bottom containing the ammonium phosphate solution having an increased ratio R of ammonium ions to phosphate ions also contains residual monomers (e.g. acrylonitrile) in small quantities. In one embodiment, these monomers are stripped and returned to the quench tower for further recovery and purification. Typical stripping gases for removal of the residual monomers from the quench bottoms comprise propane, nitrogen, carbon dioxide and carbon monoxide or mixtures thereof.

In the heating step of the process, the quench bottoms solution, stripped of useful monomers, is treated at an elevated temperature and pressure to strip ammonia from the ammonium phosphate solution by converting, e.g., diammonium phosphate to monoammonium phosphate. At this point, the ratio R of ammonium ions to phosphate ions is reduced from the increased ratio R to the initial ratio. The released ammonia is captured as a vapor stream which contains ammonia and water vapor. This ammonia-rich vapor stream is heated to remove substantially all the water and the ammonia is then recycled to the reactor. The ammonium phosphate solution which has been restored to the initial ratio R of ammonium ions to phosphate ions is recovered and recycled into the quench tower for use in the quenching step.

In the present invention, nuclear magnetic resonance, “NMR”, is used to monitor the ratio R of ammonium ions to phosphate ions in an ammonium phosphate solution such as that used in the quenching step of the process of the present invention. Specifically, a ³¹P NMR spectrum is recorded on a sample of the ammonium phosphate solution, yielding a value of chemical shift for the ³¹P NMR absorption peak. The exact value of the ³¹P chemical shift for such a sample depends on the ratio R of ammonium ions to phosphate ions in the ammonium phosphate solution. The ³¹P chemical shift of the sample ammonium phosphate solution is compared to a calibration curve to determine the ratio R of ammonium ions to phosphate ions in the sample. A calibration curve may be obtained, either by preparing standard solutions of ammonium phosphate having various ratios of ammonium ions to phosphate ions, or by empirically determining the ³¹P chemical shift of sample ammonium phosphate solutions such as the quench solution of the present process, followed by chemical analysis to determine the actual ratio R of ammonium ions to phosphate ions in the sample solution.

The relationship between the chemical shift of the ³¹P NMR absorption peak and the ratio R of ammonium ions to phosphate ions is linear at a given temperature and total solids content of the sample solution, for ratios R of ammonium ions to phosphate ions at least in the range from about 1.0 to about 2.0. The presence of other likely contaminants in the ammonium phosphate solution, such as organic acids corresponding to the unsaturated nitrites, does not affect the linearity of the R values or the linearity of the concentration of P obtained by the ³¹P NMR.

A similar relationship between chemical shift and the ratio R extends to values of R outside the range from about 1.0 to about 2.0. The relationship between chemical shift and the ratio R is linear within the range from about 1.0 to about 2.0. The relationship is linear outside this range as well. However, outside this range the slope of a line obtained by plotting chemical shift against the ratio R may vary to some extent from the slope of the line plotted for values of R within this range. For this reason, it may be necessary to recalibrate a standard curve for such values of R outside the range from about 1.0 to about 2.0, if the process is to be operated such that R may fall outside this range. The range of R from about 1.0 to about 2.0 is the broad range of most economic interest in the present process. Exemplary ranges of values of R have been provided above. While the present process may be operated outside this range, it is economically preferable to operate within this range. If the method is applied to other processes, the range of R of most economic interest may vary.

The ³¹P chemical shift is linear for ratios R ranging from 1.0 to 2.0 for a given total solids content in the ammonium phosphate solution for values of total solids at least ranging from about 5% to about 30% on a weight per volume basis. The following Table 1 shows experimental results for calibration curves obtained for total solids ranging from 5% to 30% on a weight per volume basis.

TABLE I
Comparison of Intercept and Slope for 5% to 30% Total Solids (TS)

| | 30% TS | 25% TS | 20% TS | 5% TS | 0% TS | 5% TS | ave | S.Dev. |
|---|---|---|---|---|---|---|---|---|
| Inter- | 1.0174 | 1.0050 | 1.0011 | 0.9978 | 0.9857 | 0.9941 | 1.0002 | 0.0107 |
| cept | | | | | | | | |
| Slope | 0.5263 | 0.5166 | 0.5084 | 0.4909 | 0.5051 | 0.4615 | 0.5015 | 0.0229 |

Thus, there is some variation of the slope and intercept for a standard curve for solutions having different total solids content.

In the ³¹P NMR spectrum, a single phosphorus peak appears, even when the solution is prepared with both MAP and DAP. This is due to the rapid exchange of ammonium ions (NH₄⁺) between phosphate ions (PO₄⁻³) in the ammonium phosphate solution. In solution, the equation II shown above may be represented as an equilibrium IIa:

(NH₄)H₂PO₄+NH₄^{+≈}(NH₄)₂HPO₄+H⁺ IIa

As will be understood, variations in the content of ammonium ion causes this equilibrium to shift, which causes the chemical shift of the ³¹P NMR peak to shift accordingly.

Rather than observing separate NMR signals for phosphorus atoms corresponding to each combination of ammonium ion and phosphate ion, the NMR actually observes, in essence, a single phosphorus atom which represents an average of the various combinations of ammonium ions (NH₄⁺) and phosphate ions (PO₄⁻³) at a given ratio R. For this reason, the ³¹P NMR yields a single peak, and the chemical shift of the ³¹P peak reflects the relative amounts of ammonium ions and phosphate ions, and thus the ratio R of these ions.

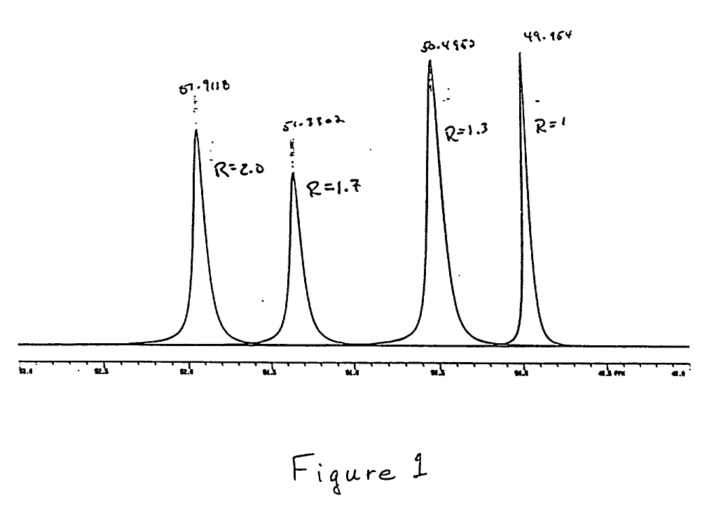

Reference is now made to FIG. 1. FIG. 1 shows a superimposition of the ³¹P NMR absorption peaks of four P³¹NMR spectra, each peak representing one ratio R of ammonium ions to phosphate ions in an ammonium phosphate solution in accordance with the present invention. As shown in FIG. 1, the four peaks correspond to the following ammonium ion to phosphate ion ratios (“R”) and chemical shifts:

| Ratio, R | Chemical Shift |
|---|---|
| R = 1 | 49.954 |
| R = 1.3 | 50.4952 |
| R = 1.7 | 51.3302 |
| R = 2.0. | 51.9118 |

It is noted that FIG. 1 is exemplary only, and the four ³¹P NMR peaks shown in FIG. 1 may not provide an perfectly linear plot of R. However, it has been determined that for a given temperature and total solids content, a plot of R against the chemical shift of the ³¹P NMR peak does give a substantially linear plot, and may be effectively used to provide improved control of the ammonia recovery process of the present invention. Furthermore, the exact chemical shift for a set of ³¹P NMR peaks may vary to some extent, but it is not the exact chemical shift which is important. Rather, it is the relationship between chemical shift of the ³¹P NMR for an ammonium phosphate solution having various ratios R of ammonium ions to phosphate ions which is important to the present invention.

Furthermore, it is noted that the exact value of the chemical shift is much less important than the relative chemical shift. The exact values of the chemical shift may vary, but the relationship between the ratio R for a given ammonium phosphate solution (in terms of composition, including total solids and at given conditions, such as temperature) and the chemical shift of the ³¹P NMR peak remains linear.

A calibration curve may be prepared by preparing and chemically analyzing standard ammonium phosphate solutions having known total solids content, by known, standard procedures, and plotting the obtained values of R against the chemical shift of the ³¹P absorption peak in the corresponding ³¹P NMR. Alternatively, a calibration curve may be prepared by empirically sampling and analyzing chemically in-process ammonium phosphate solutions, and preparing standard calibration curves based on the experimental measurements of the ratio R of ammonium ions to phosphate ions and the total solids content of each sample, and plotting these values against the chemical shift of the ³¹P absorption peak in the corresponding ³¹P NMR. Standard methods of preparing calibration curves are known to those of skill in the chemical arts, and need not be provided in detail herein.

The following tables present exemplary calibration curve data for various ratios R of ammonium ions to phosphate ions. As shown by the table, excellent correlation is obtained. Table 2 demonstrates that when several standard solutions are prepared covering the range from a value of R=1.0 to R=2.0, the line obtained by plotting the value of R against the chemical shift is linear. Table 3 demonstrates that when only two standard solutions are prepared, at values of R=1.0 and R=2.0, essentially the same values are obtained for intermediate values of R. Thus, for practical calibration use, rather than preparing a series of standard solutions, only two standard solutions need be prepared, bracketing the expected values of R. It is preferable to prepare standard solutions at values of R=1.0 and R=2.0, even in cases, e.g., in which the expected values of R are in the range from about 1.0 to about 1.4. This preference helps to avoid the possibility of magnifying small errors in preparing the standard solutions or determining the chemical shifts of the ³¹P NMR peaks of the standards.

TABLE 2
Ammonium Phosphate Standards at 35% Total Solids

| | ³¹P | | | | | |
|---|---|---|---|---|---|---|
| Actual | Chem. | Shift Diff. | Area of | Calculated | Difference | Difference |
| Ratio, R | Shift | from R = 1 | ³¹P Peak | Ratio, R | (absolute) | (%) |
| 0.783 | 51.586 | −0.113 | 2200.3 | 0.9579 | −0.175 | −22.4% |
| 1.0 | 51.699 | 0 | 3507.3 | 1.0174 | −0.017 | −1.7% |
| 1.18 | 51.993 | 0.294 | 3305.1 | 1.1721 | 0.008 | 0.6% |
| 1.4 | 52.391 | 0.692 | 3068.1 | 1.3816 | 0.018 | 1.3% |
| 1.6 | 52.797 | 1.098 | 2592.1 | 1.593 | 0.005 | 0.3% |
| 1.8 | 53.211 | 1.512 | 2598.1 | 1.8132 | −0.013 | −0.7% |
| 2.0 | 53.566 | 1.867 | 2901.3 | 2.0000 | 0.000 | 0.0% |

| | | | | |
|---|---|---|---|---|
| Correlation | 0.9994 | | Ave. | 0.0% |
| Coefficient* | | | Dev.* | |
| Y-intercept* | 1.0174 | | Std. Dev.* | 1.1% |
| Slope* | 0.5263 | 0.5356 | | |

*R = 0.8 not used to calculate these values.

TABLE 3
Ammonium Phosphate Standards at 35% Total Solids
Calculated by 2 Point Method

| | ³¹P | | | | | |
|---|---|---|---|---|---|---|
| Actual | Chem. | Shift Diff. | Area of | Calculated | Difference | Difference |
| Ratio, R | Shift | from R = 1 | ³¹P Peak | Ratio, R | (absolute) | (%) |
| 0.783 | 51.586 | −0.113 | 2200.3 | 0.9395 | −0.157 | −20.1% |
| 1.0 | 51.699 | 0 | 3507.3 | 1.0000 | 0.000 | 0.0% |
| 1.18 | 51.993 | 0.294 | 3305.1 | 1.1575 | 0.022 | 1.9% |
| 1.4 | 52.391 | 0.692 | 3068.1 | 1.3706 | 0.029 | 2.1% |
| 1.6 | 52.797 | 1.098 | 2592.1 | 1.5881 | 0.012 | 0.7% |
| 1.8 | 53.211 | 1.512 | 2598.1 | 1.8099 | −0.010 | −0.6% |
| 2.0 | 53.566 | 1.867 | 2901.3 | 2.0000 | 0.000 | 0.0% |

| | | | | |
|---|---|---|---|---|
| Correlation | 0.9994 | | Ave. | 0.7% |
| Coefficient* | | | Dev.* | |
| Y-intercept* | 1.0174 | | Std. Dev.* | 1.1% |
| Slope* | 0.5263 | 0.5356 | | |

*R = 0.8 not used to calculate these values.

The calibration curve may be prepared from two solutions each containing a known ratio of ammonium ions to phosphate ions. Of course, the more points on the curve, the less chance of error. However, as mentioned above, for practical use two standard solutions at values or R=1.0 and R=2.0 provide sufficient precision and accuracy. It is preferred to “force” the Y-intercept of the calibration curve to pass through the origin. The origin may be set for a ratio R=1, or R=zero.

Since the ³¹P NMR signal is contributed to and is therefore a measure of the absorption of each atom of phosphorus, the area under the ³¹P NMR peak is proportional to the number of phosphorus atoms in the sample analyzed, and to the concentration of phosphorus in the ammonium phosphate solution. Thus, the area of the ³¹P NMR peak may be used to calculate the P concentration in moles per liter. The area of the ³¹P NMR peak may be obtained by integrating the signal. A calibration curve may be prepared by known, standard procedures in order to provide accurate measurement of the P or PO₄⁻³ concentration. The following Table 4 shows the excellent correlation obtained for phosphorus concentration at various total solids loadings, and also shows the excellent reproducibility of the ³¹P chemical shift.

TABLE 4
Single Ratio R Over a Range of Total Solids Values

| | | | Area of | Chemical |
|---|---|---|---|---|
| | Total | | ³¹P | Shift ³¹P |
| | Solids, % | Wt %, P | Peak | Peak |
| Ratio, | 5 | 1.35% | 559.34 | 51.603 |
| R = 1.0 | 10 | 2.69% | 111810 | 51.608 |
| | 15 | 4.04% | 1348.30 | 51.615 |
| | 20 | 5.39% | 2626.10 | 51.625 |
| | 25 | 6.74% | 3194.30 | 51.621 |
| | 30 | 8.09% | 3415.60 | 51.600 |
| | correlation | | Ave. Shift | 51.612 |
| | | 0.9781 | | |
| | | | Ave. Var. | 0.010 |
| Ratio, | 5 | 1.25 | 583.37 | 52.747 |
| R = 1.5 | 10 | 2.51 | 1202.50 | 52.617 |
| | 15 | 3.76 | 1682.20 | 52.663 |
| | 20 | 5.02 | 715.81 | 52.708 |
| | 25 | 6.36 | 2481.70 | 52.391 |
| | 30 | 7.63 | 2783.50 | 52.347 |
| | correlation | 0.8180* | Ave. Shift | 52.684 |
| | | | Ave. Var. | 0.056 |
| Ratio, | 5 | 1.17% | 326.36 | 53.782 |
| R = 2.0 | 10 | 2.35% | 621.45 | 53.738 |
| | 15 | 3.52% | 1166.00 | 53.678 |
| | 20 | 4.70% | 1666.50 | 53.609 |
| | 25 | 5.87% | 2058.70 | 53.538 |
| | correlation | 0.9963 | | 53.669 |
| | | | | 0.098 |

*includes 20% TS data point; out of line

As shown by the foregoing Table 4, for a solution containing a given total solids loading, quite consistent results are obtained. The solutions used to prepare the calibration curve (also known as a standard curve) should contain substantially the same total solids content as that of the ammonium phosphate quench solution.

In the present invention, a ³¹P NMR detector is arranged to record the ³¹P NMR spectrum of the ammonium phosphate solution entering the quench tower apparatus in which the quenching step takes place. The output from the ³¹P NMR detector is used to control either or both of the quenching step and the heating step so as to provide a desired optimal ratio R of ammonium ions to phosphate ions in the ammonium phosphate quench solution used in the quenching step of the process. In an embodiment of the present invention in which a phosphate concentrating step is included, the ³¹P NMR may be used to measure the concentration of phosphate ions and thus to provide information for controlling and adjusting the phosphate concentrating step to provide an optimum concentration of phosphate ions in the ammonium phosphate solution.

In one embodiment, a second ³¹P NMR detector is arranged to record the ³¹P NMR spectrum of the ammonium phosphate solution exiting the apparatus in which the quenching step takes place. In this embodiment, the output from the second ³¹P NMR detector is used to provide further information for controlling either or both of the heating step and the quenching step in the process of the present invention.

For example, when the output from the ³¹P NMR detector monitoring the ammonium phosphate solution entering the apparatus in which the quenching step is performed shows a ratio R of ammonium ions to phosphate ions which is above a desired, optimal ratio, the time or temperature of the heating step can be modified to cause more ammonia to be driven off from the ammonium phosphate solution in the heating step, thus lowering the ratio R of the solution output from the heating step.

In another embodiment, a second ³¹P NMR detector is employed to monitor the effluent from the quenching step, prior to the heating step. In this embodiment, if the ratio R of ammonium ions to phosphate ions in the effluent from the quenching step is too high, the flow of ammonium phosphate solution fed into the quenching apparatus may be increased, or the ratio R of the solution fed into the quenching apparatus may be reduced. The reduction may be accomplished by adjusting the time or temperature of the heating step, or by addition of fresh ammonium phosphate solution to the quench solution from an outside source. Other examples of how the process steps may be controlled and adjusted, corresponding to the foregoing examples, would be understood by a person of skill in the art from the present description.

In one embodiment, the stripped quench bottom solution containing an increased ratio R of ammonium ions to phosphate ions is passed through a wet oxidation reactor where it is treated under typical wet oxidation conditions to remove any polymers formed during the ammoxidation process.

In one embodiment, the stripped quench bottom solution containing unrecoverable monomers and an increased ratio R of ammonium ions to phosphate ions is separately treated in a phosphate decomposing unit which separates the residual monomers from the remainder of the solution. The solution is then heated to regenerate monoammonium phosphate from diammonium phosphate and thereby regenerate an ammonium phosphate solution having a lower (e.g., initial) ratio R in a separate unit. Meanwhile the residual polymers are transferred to a wet oxidation unit for wet oxidation under conventional temperatures and pressure to produce harmless by-products such as carbon dioxide and water.

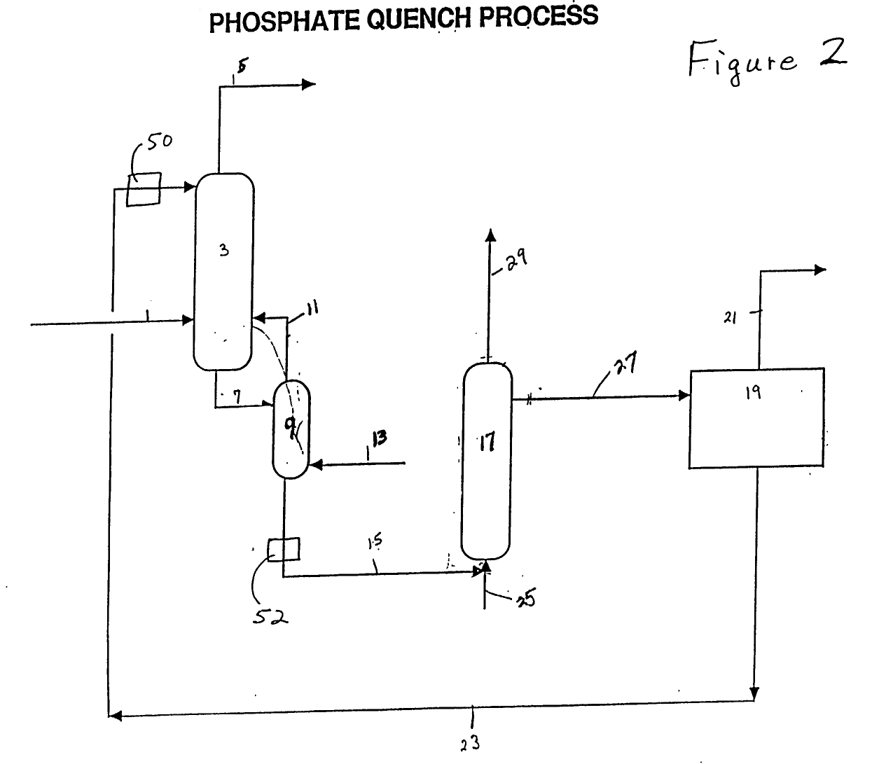

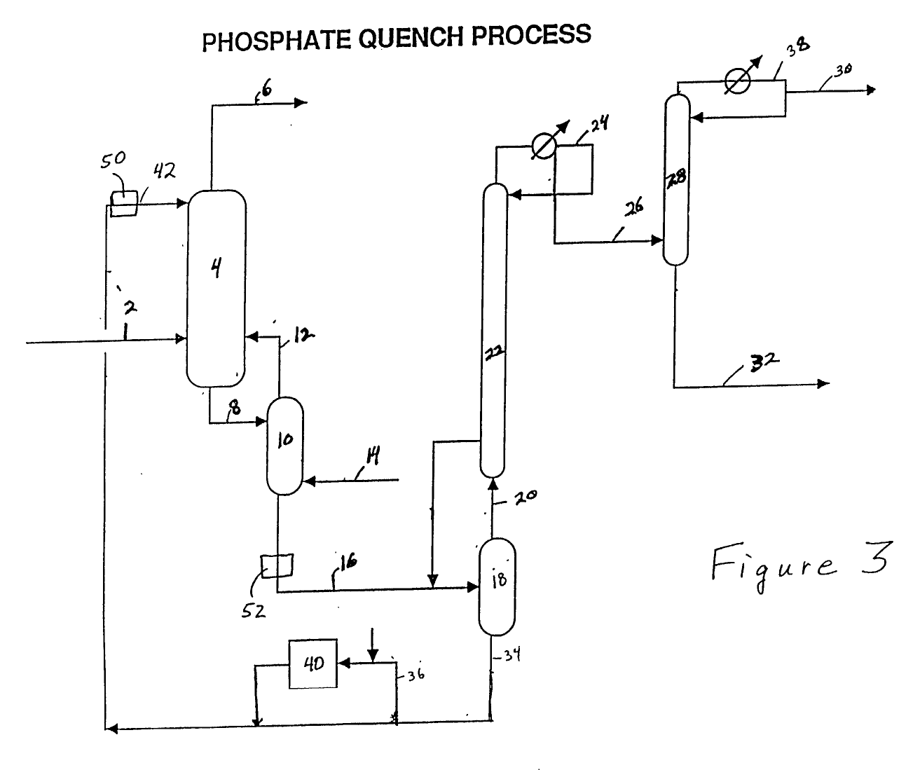

Reference will now be made to FIGS. 2 and 3 which each illustrate one embodiment of the process of the present invention as applied to propane ammoxidation. It is to be understood that propane ammoxidation is used herein as a non-limiting example only, and that the present invention is broadly applicable to any process which requires recovery of ammonia from a process stream similar to that of the propane ammoxidation, i.e., one containing organic reaction products and ammonia, in which the organic reaction products will not significantly react with or be decomposed by an aqueous solution of ammonium phosphate. Examples of other processes include ammoxidation of butane and propylene.

Referring to FIG. 2, reactor effluent, obtained from the direct reaction of a hydrocarbon, e.g., propane, ammonia and oxygen in the reaction zone, which may be, for example, a fluid bed reactor (not shown) over an ammoxidation catalyst, is passed via a line 1 into a quench tower 3. In the quench tower 3, the reactor effluent containing product acrylonitrile and unreacted ammonia is contacted with an ammonium phosphate quench solution having an initial, relatively low ratio R. The low ratio quench solution combines with unreacted ammonia present in the effluent and thereby removes ammonia from the effluent, producing an ammonia-free product overhead stream containing crude acrylonitrile, and an ammonium phosphate solution having an increased ratio R of ammonium ions to phosphate ions. The crude acrylonitrile passes overhead via a line 5 into conventional recovery and purification sections (not shown) for subsequent recovery of commercially pure acrylonitrile, crude acetonitrile and hydrogen cyanide. Examples of conventional recovery and purification procedures can be found in U.S. Pat. No. 3,936,360 incorporated by reference herein.

The ammonium phosphate quench solution having the now-increased ratio R passes to the bottom of the quench tower 3, and may be referred to as the quench bottom solution. The quench bottom solution leaves the quench tower 3 via a line 7 and enters a quench stripper 9. The ammonium phosphate solution, having reacted with ammonium ions in the quenching step, has an increased ratio R of ammonium ions to phosphate ions. A stripping gas comprising, e.g., a recycle stream comprising a mixture of propane, carbon monoxide, carbon dioxide and nitrogen is passed via a line 13 into a stripper column 9 to remove any residual acrylonitrile, acetonitrile or hydrogen cyanide contained in the quench bottom solution. The overhead stripping gas from the stripper column 9, containing these residual monomers, is recycled via a line 11 into the quench tower 3 for further recovery of useful products.

Referring still to FIG. 2, the stripped quench bottom solution is passed from the stripper column 9 via a line 15 into a wet oxidation reactor 17 wherein the heating step and a wet oxidation take place. In the wet oxidation, oxygen is passed via a line 25 and a conventional catalytic wet oxidation takes place to remove unwanted impurities such as polymers. In the heating step, the quench bottoms, comprising the ammonium phosphate solution having an increased ratio R of ammonium ions to phosphate ions, is heated to free at least a portion of the ammonium ions as ammonia gas and to thereby convert at least a portion of the diammonium phosphate in the solution to monoammonium phosphate.

The recovered ammonia is removed from the reactor 17 via a line 29. The recovered ammonia may be recycled to the axxomxidation reactor, or alternatively, may be recovered for other use.

The resulting ammonium phosphate solution is passed from the reactor 17 via a line 27 into an evaporator 19 where excess water is removed from the solution, thus forming a more concentrated ammonium phosphate solution. The more concentrated ammonium phosphate solution has the initial ratio R of ammonium ions to phosphate ions. This excess water is passed from the evaporator 19 via a line 21 for recycle or disposal. The concentrated ammonium phosphate solution with the initial ratio R is passed from the evaporator 19 via a line 23 for recycle into the quench tower 3.

As shown in FIG. 2, a ³¹P NMR detector 50 may be placed so as to sample the stream of ammonium phosphate solution passing through the line 23 from the evaporator 19 to the quench tower 3. As is commonly used in in-line chemical process monitoring, a relatively small side stream may be removed from the primary line 23 and passed through the ³¹P NMR detector 50 for analysis. Of course, while the ³¹P NMR detector 50 is shown in FIG. 2 at a position immediately preceding entry of the contents of the line 23 into the quench tower 3, this detector may be placed at any location downstream of the apparatus in which the heating step takes place, in order to monitor and control the ratio R of ammonium ions to phosphate ions in the ammonium phosphate solution after the ammonia has been removed in the heating step and while being recycled. As mentioned above, the phosphorus concentration may also be measured in the ammonium phosphate solution. In order to monitor and control both the ratio R and the concentration, the ³¹P NMR detector 50 should be installed downstream of the evaporator 19. As an alternative, two ³¹P NMR detectors could be installed, one immediately upstream and one downstream from the evaporator 19 but prior to the quench tower 3.

As shown in FIG. 2, a second ³¹P NMR detector 52 optionally may be installed downstream of the quench stripper 9, for monitoring the ratio R of ammonium ions to phosphate ions in the stream exiting the quench stripper 9 via the line 15. As an alternative, the second ³¹P NMR detector 52 may be installed in the line 7 exiting the quench tower 3, prior to the quench stripper 9.

Typical wet oxidation conditions are utilized for the destruction of the unwanted polymers obtained during the process. Typical catalysts for wet oxidation are soluble salts of copper and iron, oxides of copper, zinc, manganese and cerium and noble metals and are well known in the prior art. See, for example, Ind. Eng. Chem. Res., 1995 Vol 34, Pages 2-48, incorporated by reference herein. The wet oxidation reaction is designed for normal operation. Typically, wet oxidation is run at a pressure of between about 600 to 3000 psia and a temperature of 200° C. to 650° C.

With reference to FIG. 3 a second embodiment of the present invention is described. The process illustrated in FIG. 3 is substantially similar to that illustrated in FIG. 2, except that the ammonia release in the heating step takes place in a first phosphate decomposition unit followed by wet oxidation in a second unit. In addition, the process illustrated in FIG. 3 includes an ammonia purification and/or concentration process, for purifying and/or concentrating the recovered ammonia prior to recycling into the quench tower.

In FIG. 3, the reactor effluent obtained by the direct ammoxidation of a hydrocarbon, e.g., propane, oxygen and ammonia in a reaction zone, for example a fluid bed reactor (not shown), is passed from the fluid bed reactor via a line 2 into the quench tower 4. In a quench tower 4, the reactor effluent containing crude acrylonitrile and unreacted ammonia is contacted with an aqueous ammonium phosphate solution having an initial, relatively low, ratio R of ammonium ions to phosphate ions, which enters the quench tower 4 via a line 42. The low ratio ammonium phosphate quench solution combines with and thereby strips the unreacted ammonia from the effluent producing an ammonia-free product, including crude acrylonitrile, and an ammonium phosphate quench solution having an increased ratio R of ammonium ions to phosphate ions. The ammonia-free products pass overhead from the quench tower 4 via a line 6. These products pass overhead via the line 6 into a conventional recovery and purification section (not shown) for recovery of commercially pure acrylonitrile, crude acetonitrile and hydrogen cyanide.

The ammonium phosphate quench solution now having the increased ratio R passes to the bottom of the quench tower 4, and may be referred to as the quench bottom solution. The quench bottom solution leaves the quench tower 4 via a line 8 into a bottom stripper 10 where a stripping gas (having, e.g., the same composition as described above with reference to FIG. 2) enters the lower portion of the bottom stripper 10 from a line 14 and passes upward through the quench bottom solution to strip the solution of any useful monomers present therein such as acrylonitrile, acetonitrile and hydrogen cyanide. The overhead stripping gas from the stripper column 10, containing these residual monomers, is recycled into the quench tower 4 via a line 12 for further recovery of useful products.

Referring still to FIG. 3, the stripped quench bottom solution is passed from the bottom stripper 10 via a line 16 to a phosphate decomposer 18 in which the heating step takes place. In the phosphate decomposer 18, at least a portion of the diammonium phosphate present in the stripped quench bottom solution is converted to free ammonia and monoammonium phosphate by heating the solution to an elevated temperature (100° C. to 300° C.). Typically, the pressure is in the range from about 1 to about 5 atmospheres (i.e., from about atmospheric pressure up to about 75 psia). Oxygen may be present but is not required. The resulting ammonium phosphate solution, having a now-reduced ratio R of ammonium ions to phosphate ions, is passed from the phosphate decomposer 18 via a line 34 for recycle via a line 40 into the quench tower 4.

The free ammonia generated during phosphate conversion in the phosphate decomposer 18 is passed via a line 20 into an ammonia rectification unit 22 wherein the free ammonia is purified and passed through an optional first reflux unit 24 to an ammonia stripper 28 via a line 26 to recover the ammonia for recycle into the reactor (not shown) for manufacture of acrylonitrile. Water is recovered from the ammonia stripper 28 and passed via a line 32 for recycle or disposal. The ammonia may pass through a second reflux unit 38 prior to being recycled to the reaction zone via a line 30.

Referring still to FIG. 3, the ammonium phosphate solution passed from the phosphate decomposer 18 via the line 34 may be sent through a wet oxidation unit 40 via a line 36 for oxidative removal of polymers and conversion of these unwanted materials into harmless by-products such as hydrogen, carbon monoxide and carbon dioxide. As described previously, the wet oxidation may be performed under conventional conditions known in the art. As described previously, the concentrated ammonium phosphate solution exiting the wet oxidation having the initial ratio R of ammonium ions to phosphate ions may be passed to the quench tower 4 for further processing.

As shown in FIG. 3, a ³¹P NMR detector 50 may be placed so as to sample the stream of ammonium phosphate solution passing through the line 42 from the wet oxidation reactor 40 to the quench tower 4. As is commonly used in in-line chemical process monitoring, a relatively small side stream may be removed from the primary line 42 and passed through the ³¹P NMR detector 50 for analysis. Of course, while the ³¹P NMR detector 50 is shown in FIG. 3 at a position immediately preceding entry of the contents of the line 42 into the quench tower 4, this detector may be placed at any location downstream of the apparatus in which the heating step takes place, in order to monitor and control the ratio R of ammonium ions to phosphate ions in the ammonium phosphate solution after the ammonia has been removed in the heating step and recycled. As mentioned above, the phosphorus concentration may also be measured in the ammonium phosphate solution by the ³¹P NMR detector 50. In order to monitor and control both the ratio R and the phosphorus concentration, the ³¹P NMR detector 50 should be installed downstream of the wet oxidation unit 40. As an alternative, two ³¹P NMR detectors could be installed, one immediately upstream and one downstream from the wet oxidation unit 40 but prior to the quench tower 4.

As shown in FIG. 3, a second ³¹P NMR detector 52 optionally may be installed downstream of the quench stripper 10, for monitoring the increased ratio R of ammonium ions to phosphate ions in the stream exiting the quench stripper 10 via the line 16. As an alternative, the second ³¹P NMR detector 52 may be installed in the line 8 exiting the quench tower 4, prior to the quench stripper 10.

While the invention has been described in conjunction with specific embodiments herein, it is evident that many alternatives, modifications and variations will be apparent to those skilled in the art in light of the foregoing description. Accordingly it is intended to embrace all such alternatives and modifications in variations as for within the spirit and broad scope of the appended claims.

What is claimed is:

1. A process for the recovery of unreacted ammonia from the effluent obtained from a reaction zone wherein oxygen, ammonia and a hydrocarbon are reacted at an elevated temperature in the presence of an ammoxidation catalyst to produce an unsaturated nitrile comprising the steps of:
quenching the effluent containing the nitrile and unreacted ammonia with an aqueous ammonium phosphate solution having an initial ratio R of ammonium ions to phosphate ions to absorb substantially all of the unreacted ammonia present in the reactor effluent to form an ammonium phosphate solution having an increased ratio R of ammonium ions to phosphate ions;
heating the solution to an elevated temperature sufficient to reduce the ratio R of ammonium ions to phosphate ions and to generate a vaporous stream containing ammonia;
passing the heated solution through a ³¹P nuclear magnetic resonance detector to detect a chemical shift of a ³¹P nuclear magnetic resonance peak;
determining the ratio R of ammonium ions to phosphate ions in the solution based on the chemical shift; and
controlling the heating step to maintain the initial ratio R within a desired range.

2. A process as in claim 1, further comprising the step of recycling at least a portion of the solution to the quenching step.

3. A process as in claim 1, further comprising the steps of passing the ammonium phosphate solution having an increased ratio of ammonium ions to phosphate ions through a detector prior to the heating step, determining the ratio of ammonium ions to phosphate ions ammonium phosphate solution having an increased ratio of ammonium ions to phosphate ions.

4. A process as in claim 3, further comprising the step of controlling the heating step to maintain both the initial and increased ratios within desired ranges.

5. A process as in claim 1, further comprising a wet oxidation step.

6. A process as in claim 1, further comprising a step of increasing the concentration of the phosphate ion.

7. A process as in claim 1, further comprising the step of recycling the recovered ammonia to the reaction zone.

8. A process as in claim 1, further comprising a step of purifying the recovered ammonia.

9. A process as in claim 1, further comprising a step of concentrating the recovered ammonia.

10. A process as in claim 1, further comprising a step of contacting the quench solution with a stripping gas subsequent to the quenching step.

11. A process as in claim 9, further comprising treating the stripping gas to recover useful co-products or by-products of the ammoxidation reaction.

12. A process as in claim 1, wherein the step of determining the ratio R includes preparation of a calibration curve from at least two solutions containing a known ratio of ammonium ion to phosphate ion.

13. A process as in claim 11, wherein the calibration curve is prepared from solutions containing substantially the same total solids content as in the ammonium phosphate solution.

14. A process as in claim 1, wherein the initial ratio is in the range from about 0.7 to about 1.3.

15. A process as in claim 1, wherein the hydrocarbon is selected from propane and isobutane.

16. A process for the recovery of unreacted ammonia from the effluent obtained from a reaction zone wherein oxygen, ammonia and a hydrocarbon are reacted at an elevated temperature in the presence of an ammoxidation catalyst to produce an unsaturated nitrile comprising the steps of:
quenching the effluent containing the nitrile and unreacted ammonia with an ammonium phosphate solution having an initial ratio R of ammonium ions to phosphate ions to absorb substantially all of the unreacted ammonia present in the reactor effluent whereby the ammonium phosphate solution has an increased ratio R of ammonium ions to phosphate ions;
heating the solution to an elevated temperature sufficient to reduce the ratio R and to generate a vaporous stream containing ammonia for recycling to the reaction zone;
passing the solution through a ³¹P nuclear magnetic resonance detector to detect a chemical shift of a ³¹P nuclear magnetic resonance peak;
determining the ratio of ammonium ions to phosphate ions in the solution based on the chemical shift; and
controlling the heating step to maintain the first ratio within a desired range.

17. A process as in claim 16, further comprising a step of increasing the concentration of the phosphate ion.

18. A process as in claim 16, further comprising a step of contacting the quench solution with a stripping gas subsequent to the quenching step.

19. A process as in claim 16, wherein the initial ratio is in the range from about 0.7 to about 1.3.

20. A process for the recovery of unreacted ammonia from the effluent obtained from a reaction zone wherein oxygen, ammonia and a hydrocarbon selected from propane and isobutane are reacted at an elevated temperature in the presence of an ammoxidation catalyst to produce a corresponding unsaturated nitrile, comprising the steps of:
quenching the effluent containing the corresponding nitrile and unreacted ammonia with an ammonium phosphate solution wherein the ratio R of ammonium ions to phosphate ions is between about 0.7 to about 1.3 to absorb substantially all of the unreacted ammonia present in the reactor effluent to form an ammonium phosphate solution having an increased ratio R ammonium ions to phosphate ions;
heating the solution to an elevated temperature sufficient to reduce the amount of ammonium ions in the solution to substantially the initial ratio R present in the solution and to generate a vaporous stream containing ammonia for recycling to the fluid bed reactor;
passing the ammonium phosphate solution through a ³¹P nuclear magnetic resonance detector to detect a chemical shift of a ³¹P nuclear magnetic resonance peak;
determining the ratio of ammonium ions to phosphate ions in the solution based on the chemical shift; and
controlling the heating step to maintain the ratio R within a desired range.
